(19) United States
(12) Patent Application Publication
(10) Pub. No.: US 2004/0205489 A1
(43) Pub. Date: Oct. 14, 2004

(54) Operation of web sites on internet

(75) Inventor: Antonio R. Bogat, Duluth, GA (US)

Correspondence Address: JAMES M. STOVER, NCR CORPORATION, 1700 SOUTH PATTERSON BLVD, WHQ4, DAYTON, OH, 45479, US

(73) Assignee: NCR Corporation

(21) Appl. No.: 09/829,225

(22) Filed: Apr. 9, 2001

(51) Int. Cl. G06F 7/00

(52) U.S. Cl. 715/501.1; 707/3

(57) ABSTRACT

An approach to operating a web site. A visitor to the web site is identified, either precisely by name, or imprecisely, as by ascertaining a category to which the visitor belongs. An example of a category may be: Avid golfers between ages of 35 and 50. Once the visitor is identified, either precisely or not, the web site performs background research on the visitor and, based on the background research, tailors a web page which is delivered to the visitor. Thus, the web site delivers different web pages to different visitors. Alternately, a tailored e-mail message may be delivered to the visitor.

The invention concerns improvements for web sites on the Internet. The web sites supply information to their visitors. The invention allows the web site operators to customize the information delivered to the visitors, based on characteristics of the visitors, including possibly the identities of the visitors.

### BACKGROUND OF THE INVENTION

The Internet is becoming more widely used as time progresses. However, a possible disadvantage of the Internet is that the visitors to web sites on the Internet often appear as anonymous entities to the content providers who operate the web sites. So-called “cookies” mitigate this problem to an extent, but, in general, only provide minimal information to the content provider as to the identity of the user.

It is believed that content providers on the Internet can provide better service to users if the content providers can more accurately identify the users. For example, if a user can be identified as a member of a certain demographic class, or of a certain market segment, the content provider can deliver a more specific and helpful response to inquiries made by the user. Further, if the user can be precisely identified by name, the response can be made even more specific and helpful.

In addition, tailoring of content provided to users can serve another purpose. For example, sometimes users of the Internet utilize a search engine to perform a search, but receive many search results, or “hits,” which are irrelevant. However, the user cannot necessarily identify the irrelevant hits immediately, but must visit, and examine, the web sites indicated by the hits, in order to identify the irrelevant sites.

If the content providers operating the web sites could identify the users in some way, such as by demographic characteristics or other methods, the content providers could immediately tell the user, when the user visits the web site, that more relevant sites are perhaps available. In effect, the content providers could inform the visitor that a false hit occurred.

### OBJECTS OF THE INVENTION

An object of the invention is to provide an improved system for operating web sites on the Internet.

A further object of the invention is to provide a system of operating web sites on the Internet, wherein content providers identify visitors, or traits of the visitors, and make trait-specific responses to the visitors.

### SUMMARY OF THE INVENTION

In one form of the invention, a web site identifies a visitor visiting the web site. The web site then performs background research on the visitor. Based on the background research, the web site assembles a web page for the visitor, which contains both (1) content specific to the visitor and (2) generic to all visitors. Thus, different visitors receive web pages having different content.

### BRIEF DESCRIPTION OF THE DRAWINGS

FIG. 1 is a representation of the Internet.

FIG. 2 illustrates a microcomputer 6 visiting a web site 12.

FIG. 3 is a flow chart illustrating processes undertaken by one form of the invention.

FIG. 4 illustrates the web site 12 obtaining personal information on a visitor from sources CIM and CPM.

FIG. 5 illustrates the web site 12 assembling a web page 500, and delivering it to microcomputer 6.

### DETAILED DESCRIPTION OF THE INVENTION

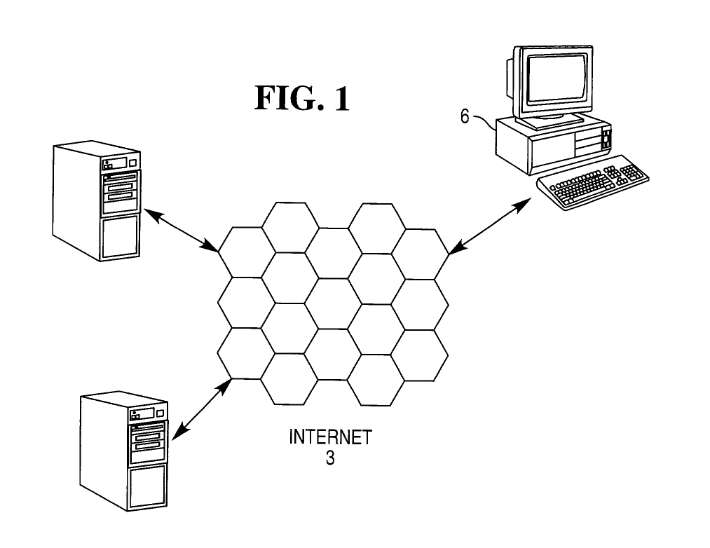

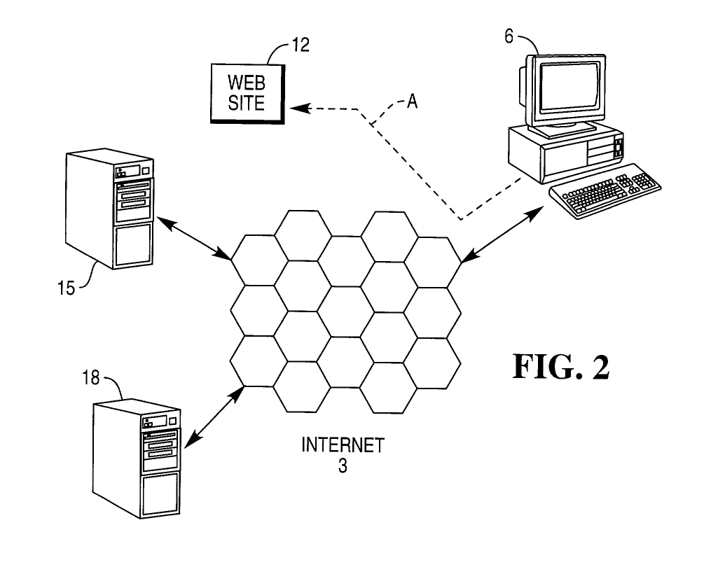

FIG. 1 is a schematic representation of the Internet 3. A user of the Internet may operate a micro-computer 6, and thereby contact a web site 12 in FIG. 2, which is maintained by a content provider (not shown) by means of server 15. The content delivered to the user may be stored exclusively in server 15. However, in the more general case, some, or all, of the content can be retrieved from other servers, repersented by server 18, and delivered to the user.

In one form of the invention, the web site 12 which the user visits makes an attempt to identify the user. Different levels of identification are possible. As one example, the web site may attempt to identify the user as male or female. As another example, the web site may attempt to identify the user based on age. The web site may try to bracket the user into the following age categories: under 21 years, 22-35 years, and over 35 years. As a third example, the web site may attempt to identify the annual income of the user.

Numerous different classifications of users may be used, and many of these classifications are well known. Many of the classification systems divide the users into groups called market segments.

In addition, the invention may attempt to identify the individual user specifically, as, for example, Maxwell Jacobs, of 383 Willow Terrace, Atlanta, Ga.

Known techniques can be used to specifically identify the user. For example, the user may be directly asked to identify herself.

As another example, the user may have previously placed an order for merchandise with a web site. At that time, the user would have divulged the user's name and address, and other information. The web site may have placed a “cookie” into the user's computer, identifying the user by serial number. When the user later visits the web site, the web site locates the cookie within the user's computer, obtains the serial number, and uses the serial number to identify the user at the later time.

As a third example, the web site may use a previous cookie to inferentially identify the user, based on other information obtained about the user from various sources.

Therefore, as a preliminary step, the invention either (1) identifies one or more categories to which a visitor to a web site belongs, or (2) identifies the visitor precisely by name.

In a subsequent step, the invention delivers information to the user which is relevant to the identity, or category, of the user. For example, assume that the web site utilizing the invention maintains a specific product line, such as bicycles. When a customer visits the web site, and makes inquiry about a product, the operator of the web site would like to know certain information about the customer, in order to tailor a response which is more fitting to the customer's needs.

For instance, the web site would probably make one type of response if the web site knew the customer to be a professional bicycle racer, who earned money in races. The web site would probably make another type of response if the customer were known to be a strict amateur. The web site would probably make a third type of response, based on the customer's income.

Therefore, prior to delivering information to a visitor, the web site selects a collection of information which is deemed relevant to the category of customer making inquiry. For example, assume that the customer requested information on bicycle gear-shifting mechanisms, commonly called derailleurs. If the customer were known to be a professional racer, the web site would deliver information about professional equipment, which is commonly constructed of alloys which are extremely light in weight, somewhat weaker in strength, and significantly more expensive than “tourist grade” equipment.

If the customer were known to be an amateur, then the web site would deliver information about the most commonly purchased derailleurs. If the customer were known to be an amateur of high income status, the web site would deliver information about the more expensive derailleurs, which are still commonly purchased. Or it may deliver information about the derailleurs which are most commonly purchased by customers in similar income class, or category, of the visiting customer.

In determining the type of information to deliver to the customer, a database of customer traits is consulted. The database may contain traits which are specific to the visiting customer, if the customer's identity is known. Alternately, if the customer's identity is not known, but the customer has been categorized, the traits of the customer's category are used.

The database contains information, of the type commonly called “demographic” information, which describes certain behaviors, and other characteristics, of the customer, or the members of the customer's category. This supply of information is herein called the customer database, or category database. In one form of the invention, the database can take the form of a relational database, which is searchable by field in the usual manner.

In one form of the invention, the databases may remain fixed, once generated. However, since facts about the customer, or members of a category, may change over time, in another form of the invention, the database can be modified as changes occur.

The information within the databases can be of different types. One type may indicate financial information: annual income, value of house, value of automobiles, amount spent monthly on food, and so on.

Another type may contain “consumer information”: make and model of automobiles, age of those automobiles, frequency of clothing purchases, and so on. Consumer information in general indicates the spending habits of the customer.

A third type may include “family” information: number and sex of children, number of marriages, and so on.

A fourth type may include medical information for the customer, and the customer's immediate family.

A fifth type may include “preference” information, which would be inferable from observation of the customer's behavior, but which can also be obtained by questioning the customer. For example, the customer can be asked whether she prefers chocolate ice cream over orange sherbet, or whether he prefers a white automobile to a blue one. Other categories are, of course, possible.

The types are not necessarily discrete, and may overlap. They may contain parallel information, and information in one type may allow a prediction of information in another type. As an example of a prediction, if an entry in the “consumer information” type indicates that the customer owns a particularly expensive automobile, then it is likely that the “financial information” type will indicate a high income. Thus, a certain amount of redundancy may exist in the overall information.

### Flow Chart

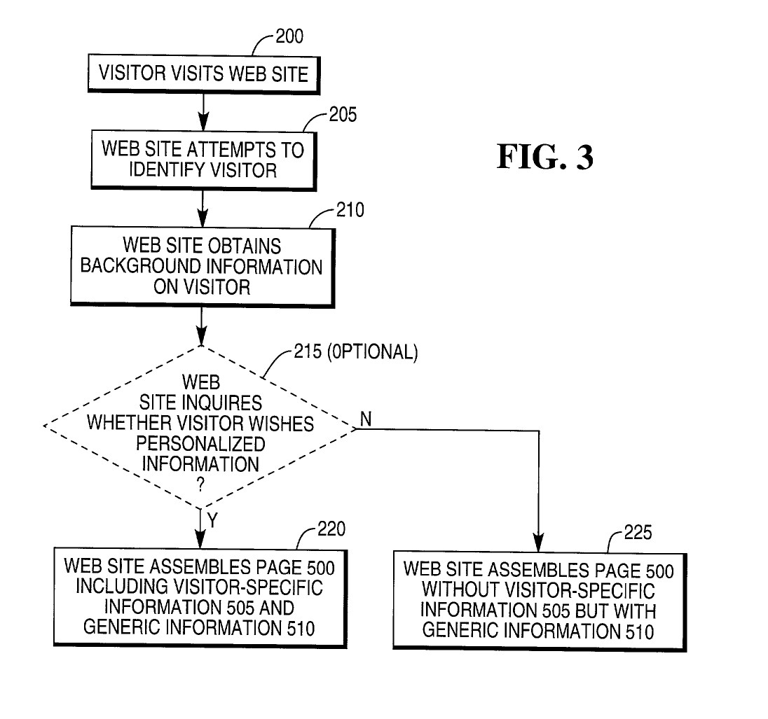

FIG. 3 is a flow chart illustrating steps taken in one form of the invention. In block 200, a visitor visits a web site, as schematically illustrated by the arrow A in FIG. 2 leading to web site 12. In block 205 in FIG. 3, the web site 12 attempts to identify the visitor, or identify a class of persons to which the visitor belongs.

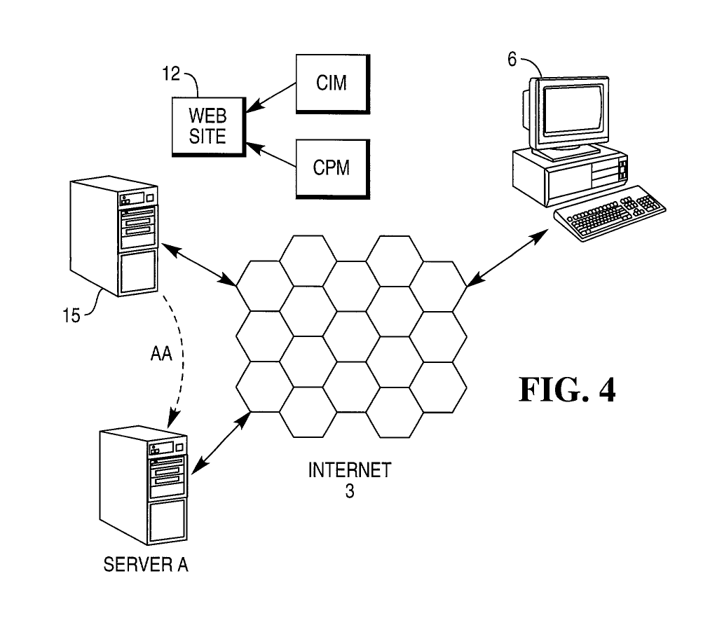

In block 210, once the web site 12 makes the identification, the web site obtains information about the person, or class. This is represented in FIG. 4 by blocks CIM, Customer Information Module, and CPM, Customer Personalization Module. Such data modules are well known. Consumer credit reporting agencies maintain such modules. Other sources of consumer information are also available, such as city directories, which publish various personal data about inhabitants of the city.

In addition, the visitor may maintain a private database about herself, somewhat analogous to a resume or curriculum vitae, and the visitor may make that database available to the web site.

For example, the web site 12 may ask whether the visitor maintains a private database, and whether the visitor wishes to give the web site the URL (Uniform Resource Locator) of the CIM. If so, the visitor gives the URL to the web site 12. The web site 12 contacts the URL and obtains information about the person. Dashed arrow AA in FIG. 4 indicates this contact.

Security measures can be imposed on access to the private database. For example, the web site 12 can be allowed to obtain data from the visitor's private database only once. This can be enforced by the visitor's giving a password to the web site which expires after a single use.

Other security measures are possible, and are described in text Applied Cryptography, by Bruce Schneier (John Wiley & Sons, New York, 1996, ISBN 0 471 12845 7). This text is hereby incorporated by reference.

After the web site 12 obtains background information about the visitor, optional block 215 in FIG. 3 is reached, wherein the web site inquires whether the visitor wishes to receive personalized information. If the visitor answers affirmatively, the YES branch is taken, and block 220 is reached.

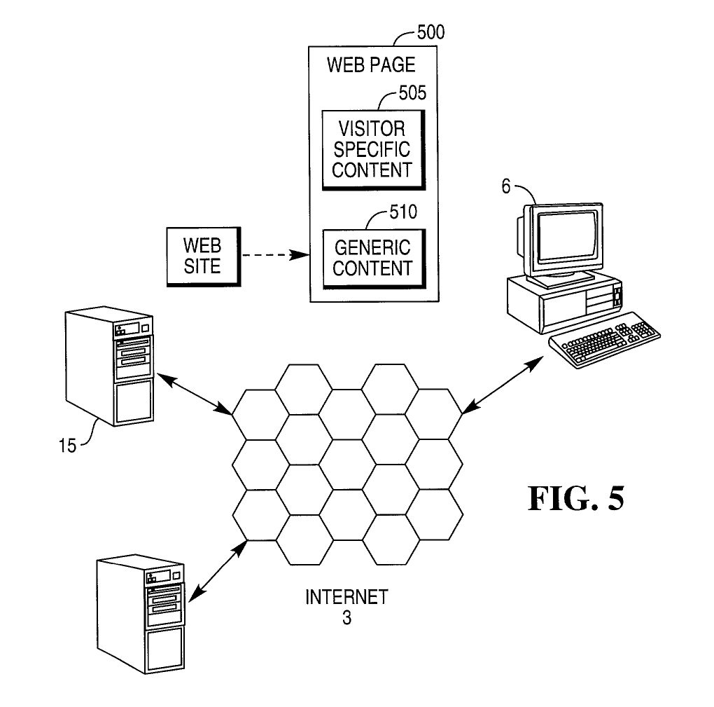

In that block, the web site assembles a web page 500, as indicated in FIG. 5, and delivers it to the visitor. The web page 500 contains data which is specific to the visitor, the data being represented by block 505. The web page also contains data which is not specific to the visitor, and is contained in other web pages, delivered to other visitors. This data is represented by block 510.

If the visitor answered negatively in block 215 in FIG. 3, the NO branch is taken, and block 225 is reached. In that block, only generic information 510 is delivered to the visitor.

It was stated that block 215 is optional. If the web site does not use it, then the process flow of FIG. 3 is directly from block 210 to block 220.

If the visitor cannot be satisfactorily identified in block 205, then the process may flow directly to block 225, wherein no significant visitor-specific information is delivered to the visitor.

### Additional Considerations

1. The invention, as described above, was framed in terms of a web site delivering web pages to visitors. The invention can also be used in e-mail messages delivered to parties making inquiries. For example, a person may surf the Internet in search of greenhouses and sunrooms. The person may locate a site, and send an e-mail inquiry to the operator of the site.

The operator may perform background research on the visitor, to ascertain whether the visitor actually owns a home. If so, the operator will respond with a detailed e-mail message, to which is perhaps attached a sales brochure in electronic form. If not, the operator may give a more abbreviated response.

2. In one form of the invention, at least some background information about the visitor is obtained from other web sites. That is, the web site visited obtains information as to the identity of the visitor, or a class to which the visitor belongs, and then contacts another web site, to obtain background information about the visitor.

3. The process of making a determination as to whether the visitor belongs to a certain category of people is tantamount to ascertaining, or estimating, whether the visitor possesses certain characteristics, namely, the characteristics defining the category. It is emphasized that absolute accuracy in making the determination is not required, although it may be desirable. An estimate can be sufficient, for many purposes.

4. As a simple example, a web site may maintain two collections of information. The first is applicable to visitors over age 25. The second is applicable to visitors of age 25-and-under.

The web site makes a guess at the age of a visitor. Based on the guess, the web site selects information from either the first or second group, and places it into block 505 in FIG. 5. In addition, the web site delivers generic content 510.

5. In another form of the invention, the web site can deliver the same information to all visitors. However, based on the identification of a visitor, some of the information can be emphasized, as by being presented first, or in larger type, or in a more emphatic color, or using animation, etc.

6. It is emphasized that one form of the invention implements a two-fold process. One, in response to an inquiry of a visitor, generic information is delivered. That information is delivered to any visitor who makes the inquiry. Two, based on identification of a visitor, or of group membership of the visitor, visitor-specific information is delivered. The latter information is not, in general, delivered to other visitors, although it can be if the others were identified as having similar traits as the visitor in question.

7. The process of performing background research and identifying the visitor may, in some cases, be combined. That is, a certain web site may identify the visitor as a skilled amateur chef between ages of 30 and 40. That identification may provide sufficient background information for the web site to construct the web page 500 in FIG. 5. On the other hand, another web site may perform further background research on such a person, such as what type of automobile that person drives, and so on.

8. It should be observed that visitor-specific information refers to information which is made visible to the visitor. For example, when a person logs onto the Internet using an Internet Service Provider, ISP, the ISP may assign the person a temporary identifying number. The ISP may transmit that number to web sites which the person visits. The purpose of that transmission is to allow the ISP to route the web site's response to the person in question.

That is, the ISP serves multiple persons, who visit multiple different web sites at any given time. The ISP must know where to route the data packets received from each web site, and it uses the temporary ID for that purpose. For example, the ISP may transmit a request to web site A, saying, in effect, “Send me data packet X for temporary ID holder Z.” The web site responds with data packet X, and includes the label “ID HOLDER Z.” That label tells the ISP that the particular data packet is intended for the person then assigned the ID number Z.

However, such ID numbers are not considered visitor-specific information. One reason is that they are not presented in the web page received. If the visitor wishes to see that ID number, the visitor must take advanced steps in dealing with the visitor's browser.

Another reason is that the ID number, if used at all, was merely returned by the web site to the ISP. That is not visitor-specific content.

A third reason is that the ID number was not derived, based on ascertainment of the visitor's identity. As stated, it was merely echoed back to the ISP.

A fourth reason is that the ID number is merely a record-keeping device. After the visitor logs off, that ID number may be used for other visitors. It is not really specific to the visitor.

Numerous substitutions and modifications can be undertaken without departing from the true spirit and scope of the invention. What is desired to be secured by Letters Patent is the invention as defined in the following claims.

What is claimed is:

1. A method of operating a web site, comprising:
a) identifying a first visitor to the web site;
b) performing background research on the first visitor;
c) based on the background research, selecting first information from a collection of information; and
d) transmitting the first information to the first visitor.

2. Method according to claim 1, and further comprising:
e) identifying a second visitor to the web site;
f) performing second background research on the second visitor;
g) based on the second background research, selecting, from the collection of information, second information which is different from the first information; and
h) transmitting the second information to the second visitor.

3. Method according to claim 1, wherein the first background research comprises contacting another web site.

4. Method according to claim 2, wherein the second background research comprises contacting said other web site.

5. A method of operating a web site, comprising:
a) receiving an inquiry from a visitor to the web site;
b) estimating whether the visitor possesses selected characteristics;
c) based on the estimate, selecting first information from a collection of information;
d) in response to the inquiry, selecting second information; and
e) compiling the first and second information into a message, and transmitting the message to the visitor.

6. Method according to claim 5, wherein the message comprises a web page.

7. Method according to claim 5, wherein the message comprises an electronic mail message.

8. Method according to claim 5, wherein the selected characteristics comprise the specific identity of the visitor.

9. Method according to claim 8, wherein the selected characteristics contain no characteristics in addition to the specific identity of the individual.

10. A method of operating a web site, comprising:
a) receiving an inquiry from a visitor to the web site;
b) ascertaining identity of the visitor;
c) based on the identity, deriving visitor-specific information;
d) based on the inquiry, deriving response information; and
e) compiling the visitor-specific information and the response information into a message, and transmitting the message to the visitor.

11. Method according to claim 10, wherein the message comprises a web page.

12. Method according to claim 10, wherein the message comprises an electronic mail message.

13. A method of operating a web site, comprising:
a) receiving an inquiry from a visitor to the web site;
b) making an estimate of selected characteristics of the visitor;
c) asking the visitor whether customer-specific information is desired and, if so, deriving customer-specific information based on the estimate;
d) based on the inquiry, selecting second information from the collection; and
e) compiling the first and second information into a message, and transmitting the message to the visitor.
